(19) United States
(12) Patent Application Publication
(10) Pub. No.: US 2010/0245773 A1
(43) Pub. Date: Sep. 30, 2010

(54) IMAGE DISPLAY APPARATUS

(76) Inventor: Shinichi Arita, Osaka (JP)

Correspondence Address: BIRCH STEWART KOLASCH & BIRCH, PO BOX 747, FALLS CHURCH, VA, 22040-0747, US

(21) Appl. No.: 12/675,244

(22) PCT Filed: Aug. 25, 2008
(86) PCT No.: PCT/JP2008/065073

§ 371 Date: Feb. 25, 2010

(30) Foreign Application Priority Data
Aug. 29, 2007 (JP) 2007-222532

(51) Int. Cl. G02B 27/48; G02F 1/03; G02F 1/035; G03B 21/14

(52) U.S. Cl. 353/31; 359/279

(57) ABSTRACT

To provide an image display apparatus in which provision of a mechanical mechanism is not required for reducing an effect of a speckle noise that is generated when a coherent light is used as a light source and a noise can be suppressed. An image display apparatus (1) changes phase of a light emitted from a light source device (a laser light source device (10) including laser light sources (10a to 10c) for each of R, G, and B colors is shown as a sample) at high speed by a phase change portion including an electro-optical crystal (phase change portions (12a to 12c) corresponding to each laser are shown as a sample). Therefore, because an interference pattern on a screen (16) changes at high speed and it is averaged by the human eye, the speckle noise can be reduced.

### TECHNICAL FIELD

The present invention relates to an image display apparatus, and, more particularly, to an image display apparatus using a coherent light such as a laser beam as its light source.

### BACKGROUND ART

There is a projector (projection-type image display apparatus) that performs image display by irradiating light from a light source device to a spatial light modulating device such as a liquid-crystal panel and projecting an image onto a screen. Conventionally, lamps such as a high-pressure mercury lamp and a metal halide lamp have been used as the light source of the projection-type image display apparatus.

Such lamps, however, not only have problems of a short life and a long time to light on but also need an optical system to separate the light from the light source into three primary colors of red, green, and blue, presenting problems of a reduction of light usage efficiency, complexity of structure, and lack of color reproducibility. Recently, for solving such problems, the image display apparatus is proposed that uses a laser beam.

By using the laser as the light source, a large number of improvements are expected such as a longer life, a wider color gamut, reduced power consumption due to good light usage efficiency, and a smaller size owing to a simplified optical system. In the image display apparatus using the laser, however, because of a coherent light of the laser, scattered lights from individual points on the screen overlap one another and interfere with one another, resulting in generation of a speckle pattern. Such a speckle pattern is called a speckle noise and is responsible for a glare or lights and darks of an image, which results in significant lowering of the image quality.

Conventionally, some methods have been proposed to reduce this speckle noise (see, e.g., patent documents 1 and 2). The patent document 1 discloses a method of reducing the speckle noise by sending an airflow to a receiving portion such as a screen to vibrate it. By constantly changing the shape of the receiving portion, this method keeps points of interference of reflected lights changing constantly and makes light intensity appear to be averaged to the human eye. For this reason, the speckle noise appears to have been reduced to an observer.

The patent document 2 discloses a method of providing a diffusion device on the path of the laser beam and rotating this diffusion device at high speed by a motor. By rotating the diffusion device at high speed in between the light source and the screen, this method changes the speckle noise pattern on the screen at a speed beyond human perception and reduces the speckle noise.

Patent document 1: Japanese Laid-Open Patent Publication No. 2005-107150

Patent document 2: Japanese Laid-Open Patent Publication No. 06-208089

### DISCLOSURE OF THE INVENTION

### Problems to Be Solved by the Invention

In the case of reducing the speckle by mechanical operation as in the methods described in the patent document 1 and patent document 2, however, a mechanism is required for vibrating or rotating, which makes the apparatus complicated and large in size. Furthermore, such a mechanism has a problem of a short life due to mechanical failures or a problem of noises generated by the vibration.

The method of vibrating the receiving portion as in the patent document 1 has problems such as the one that the method becomes difficult to implement when the screen comes to have a large size and the one that a necessity of preparing a special screen makes the existing screen unusable, resulting in high cost. The method of rotating the diffusion device at high speed as in the patent document 2 has a problem that while a driving portion is required to move at high speed, the limit of the speed is small.

The present invention was conceived in light of such situations and the object of the present invention is to provide an image display apparatus that has no necessity of providing a mechanical structure and that is capable of suppressing noises, to reduce the effect of speckle noises caused when using a coherent light such as a laser beam as a light source.

### Means to Solve the Problems

To solve the above problems, a first technical means of the present invention is an image display apparatus comprising a light source device that emits a coherent light; an image forming means that forms an image on a screen; and a phase change portion disposed on a path of the light from its emission from the light source device until its arrival at the image forming means, wherein the phase change portion comprises an electro-optical crystal, the phase change portion driving to control a voltage applied to the electro-optical crystal so as to change phase of the light to be projected onto the screen, the phase change portion changing the phase of the light to be projected onto the screen depending on the wavelength of the light emitted from the light source device.

A second technical means is the image display apparatus of the first technical means, wherein the phase change portion is an optical waveguide using the electro-optical crystal.

A third technical means is the image display apparatus of the first technical means, wherein the phase change portion drives to control the electro-optical crystal with the applied voltage of a frequency of 60 Hz or more.

A fourth technical means is the image display apparatus of the first technical means, wherein the phase change portion drives to control the voltage applied to the electro-optical crystal so as to change at random the phase of the light emitted from the light source device.

A fifth technical means is the image display apparatus of the first technical means, wherein the light source device comprises a plurality of laser light sources, wherein the phase change portion is individually disposed on a path of each of the lasers emitted from the plurality of laser light sources, and wherein the plurality of phase change portions disposed change the phase of the lasers to be projected onto the screen depending on the wavelength of the lasers emitted from the laser light sources corresponding to the paths on which the plurality of phase change portions are disposed.

A sixth technical means is the image display apparatus of the first technical means, wherein the light source device comprises a plurality of laser light sources, and wherein the phase change portion is singly disposed on a path of light after merging of the lasers emitted from the plurality of laser light sources, the phase change portion changing the phase of the laser to be projected onto the screen depending on the wavelength of the laser emitted from predetermined one of the plurality of laser light sources.

A seventh technical means is the image display apparatus of the first technical means, wherein the electro-optical crystal has a primary electro-optical effect of changing its refractive index in proportion to applied electric field.

An eighth technical means is the image display apparatus of the seventh technical means, wherein the electro-optical crystal is lithium niobate.

A ninth technical means is the image display apparatus of the first technical means, wherein the electro-optical crystal has a secondary electro-optical effect of changing its refractive index in proportion to square of applied electric field.

A tenth technical means is the image display apparatus of the first technical means, comprising an optical fiber that propagates the light emitted from the light source device to the phase change portion.

An eleventh technical means is the image display apparatus of the first technical means, wherein the light source device is a semiconductor laser.

A twelfth technical means is the image display apparatus of the first technical means, wherein the image forming means forms the image by a scanning system.

A thirteenth technical means is the image display apparatus of the first technical means, wherein the image forming means comprises a spatial light modulating device and forms the image by the spatial light modulating device.

### EFFECT OF THE INVENTION

According to the image display apparatus of the present invention, there is no necessity of providing a mechanical structure and noises are suppressed, to reduce the effect of speckle noises caused when using a coherent light such as a laser beam as a light source.

### BRIEF DESCRIPTION OF DRAWINGS

FIG. 1 is a diagram of a configuration example of an image display apparatus according to a first embodiment of the present invention.

FIG. 2 is a diagram of a configuration example of the image display apparatus according to a second embodiment of the present invention.

FIG. 3 is a diagram of a configuration example of the image display apparatus according to a third embodiment of the present invention.

FIG. 4 is a diagram of a configuration example of the image display apparatus according to a fourth embodiment of the present invention.

### EXPLANATIONS OF REFERENCE NUMERALS

1, 2, 3, 4 . . . image display apparatus, 10 . . . laser light source device, 10a to 10c . . . laser light source, 11a to 11c, 30a to 30c . . . condenser lens, 12, 12a to 12c . . . phase change portion, 13, 13a to 13c, 21a to 21c, 41a to 41c, 42 . . . collimating lens, 14a to 14c . . . dichroic mirror, 15 . . . MEMS minor, 16 . . . screen, 31, 31a to 31c . . . optical fiber, 40 . . . diffusion device, 43a, 43b . . . fly-eye lens, 44 . . . condenser lens, 45 . . . mirror, 46 . . . spatial light modulator, 47 . . . projection lens

### BEST MODES FOR CARRYING OUT THE INVENTION

An image display apparatus according to the present invention will now be described citing embodiments and referring to drawings. A projector may be given as an example of the image display apparatus according to the present invention and more effect is expected when the projector is incorporated into mobile equipment including, in particular, a cellular phone. In fact, at present, despite flourishing development of an ultra-compact laser projector in consideration of incorporation into the cellular phones, etc., the problem of the speckle noise is hardly solved. The present invention, which is capable of reducing the speckle with a simple configuration and with no mechanical parts as described later, will be useful particularly for small equipment such as the mobile equipment.

### First Embodiment

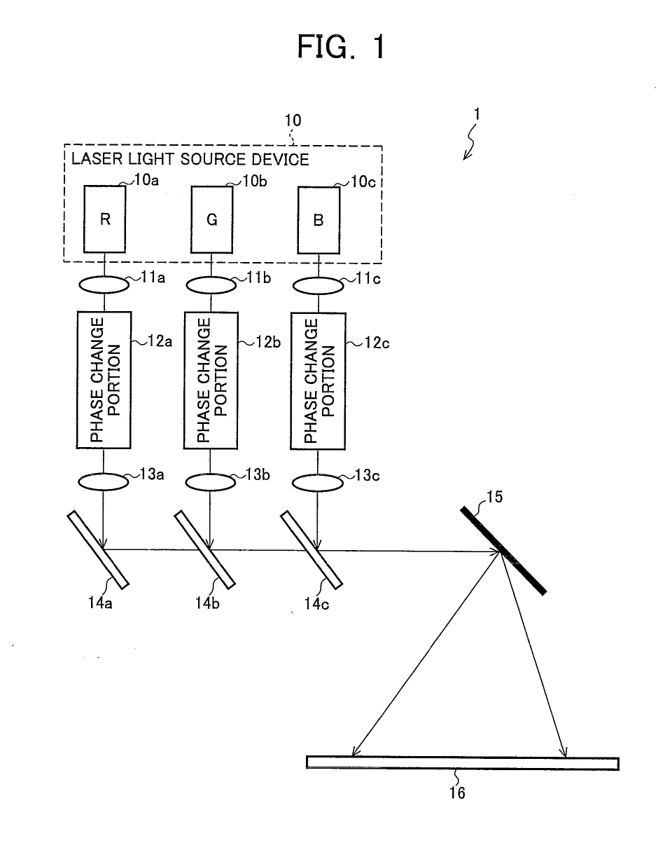

FIG. 1 is a diagram of a configuration example of the image display apparatus according to a first embodiment of the present invention and reference numeral 1 in the drawing represents the image display apparatus.

The image display apparatus 1 exemplified in FIG. 1 is composed of a laser light source device 10 including laser light sources 10a to 10c of R (red), G (green), and B (blue), condenser lenses 11a to 11c that cause output beam of light to enter phase change portions 12a to 12c, the phase change portions 12a to 12c that have electro-optical crystals and change the phase of laser beams, collimating lenses 13a to 13c that collimate beams of light from the phase change portions 12a to 12c into parallel light, dichroic mirrors 14a to 14c that reflect only wavelengths of respective beams, an MEMS (Micro Electro Mechanical Systems) mirror 15 that forms an image by a scanning system, and a screen 16 that displays the image.

The laser light source apparatus 10 may be implemented by configuring each color laser light source, for example, as follows. The laser light source 10a is configured as a semiconductor laser that irradiates a red laser beam, the laser light source 10b is configured as a laser that irradiates a green laser beam by combining the semiconductor laser and an optical-waveguide SHG (Second Harmonic Generation) device, and the laser light source 10c is configured as a semiconductor laser light source that irradiates a red laser beam. In the laser light source 10, the lights emitted from the laser light sources 10a to 10c have their light intensity individually controlled.

The laser light source may be a solid-state laser or a gas laser and the wavelengths and the kinds of the laser are not limited to those shown here. A plurality of lasers may be combined and in such case, the laser beam of further increased intensity may be obtained and a bright image may be formed. The semiconductor laser, which is a small and high-efficiency laser light source already under mass production, enables cost reduction, a smaller size of the device, and bright image display. A light source device that irradiates the coherent light other than the laser beam, for example, a device that irradiates monochromic incoherent light and passes it through a pinhole, may be employed in place of the laser light source device 10.

Beams emitted from the R, G, and B laser light sources 10a to 10c are condensed by the condenser lenses 11a to 11c, respectively and enter the phase change portions 12a to 12c, respectively. As shown in the drawing, the phase change portions 12a to 12c are individually disposed on the path of the laser beams emitted from the plurality of laser light sources 10a to 10c, respectively. Arrangement of the phase change portion for each laser light source makes it possible to perform optimum phase change depending on the wavelength of the laser light source and make the phase change efficiently. It should be noted, however, that the phase change portion provided in the present invention is not required to be arranged for each laser light source but that it is sufficient if the phase change portion is disposed in the light path from the emission of the beam from the laser light source device 10 until its arrival at an image forming means exemplified by the MEMS mirror 15.

The phase change portions 12a to 12c drive to control the voltage applied to the electro-optical crystal so as to change the phase of the light projected onto the screen 16 at high speed. That is to say, the phase change portions 12a to 12c enable the phase of the beam projected onto the screen 16 to be changed.

To make this control easy-to-execute, it is preferable that the phase change portions 12a to 12c are composed of the optical waveguide using lithium niobate (LiNBO₃). The optical waveguide using the lithium niobate is already in practical use as a modulator that superimposes a signal over the laser beam in, for example, the field of optical communication and has stabilized efficiency and high-speed responsiveness in GHz range.

Here, the lithium niobate is one of electro-optical crystals having the property of changing the refractive index with application of electric field and the phase change portions 12a to 12c, using such change of the refractive index of the electro-optical crystal, change the phase of the light propagating in the optical waveguide. Further, the lithium niobate is a crystal having a primary electro-optical effect of changing the refractive index in proportion to the applied electric field (actually, applied voltage).

Thus, employing as an electro-optical crystal the one having the primary electro-optical effect (Pockels effect) makes it easier to control the amount of phase change of the laser beam. The lithium niobate, which has a great electro-optical effect, not only is capable of performing the phase change efficiently but also is already in practical use in the field of the optical communication and is capable of stabilized efficiency and cost reduction.

With respect to the electro-optical crystals, the electro-optical crystals other than the lithium niobate may be employed. As to other electro-optical crystals, a wide variety of electro-optical crystals may be applied including, for example, a LiTaO₃ crystal having optical property, non-linear property, and optical property similar to those of the lithium niobate, a KTiPO₄ (KTP) crystal, etc. With respect to the electro-optical crystals to be mounted, several optimum kinds of electro-optical crystals may be combined for each laser. In such a case, the efficiency of the phase change may be further improved.

In particular, by using a secondary electro-optical crystal having a secondary electro-optical effect (Kerr effect) whereby the refractive index changes (changes non-linearly like) in proportion to square of the applied electric field, for example, PLZT, a big phase change may be given by a small drive voltage and the power consumption may be reduced.

The phase change portions 12a to 12c should preferably be the optical waveguide as shown herein but it is sufficient if the phase change portions 12a to 12c at least have the electro-optical crystal and are capable of controlling it. With the phase change portion configured as the optical waveguide using the electro-optical crystal, the phase change may be made with low control voltage and with efficiency and therefore, the phase change portion may be made smaller as compared with the case of not being configured as the optical waveguide. Capability of making an electrical/optical response very speedily makes it possible to perform ultra-high-speed phase change in the GHz range. The phase change portion may also be configured as a curved optical waveguide and this configuration may change the direction of progress of the beam, enabling a layout to be made freely.

The phase change in the phase change portions 12a to 12c is controlled by the voltage applied to the electro-optical crystal. This control voltage is applied to the electro-optical crystal at a drive frequency of, for example, 60 Hz or more and at this moment, the light that has entered the phase change portions 12a to 12c undergoes the phase change at that frequency.

Thus, it is preferable that the phase change portions 12a to 12c are driven at the frequency of 60 Hz or more. 60 Hz is the upper limit of the speed at which human being may perceive a flicker and by changing the phase at a speed higher than that, the observer may no longer distinguish the flicker visually and with the intensity averaged, the speckle noise on the screen is reduced.

As described above, the optical waveguide using the lithium niobate has the high-speed responsiveness in the GHz range and in implementation, is capable of the phase change at the speed of dozens Hz to the GHz range (the speed that is difficult to attain by a mechanical structure) at the present moment. Thus, the phase change portions 12a to 12c may be configured to be drivable at a free speed up to an ultra-high-speed range and are capable of easily performing the phase change at the optimum drive frequency depending on audiovisual environment and the observer. Generally speaking, however, when the voltage application to the electro-optical crystal is driven by a control signal of the frequency of 60 Hz or more (in the order of, e.g., several hundred Hz), such is difficult to perceive for human being and the speckle noise may be reduced.

The amount of the phase change in the phase change portions 12a to 12c is controlled by the voltage applied to the electro-optical crystal. That is to say, since the amount of the phase change for the voltage applied to the electro-optical crystal is determined depending on the wavelength of the light entering the phase change portions 12a to 12c, the amount of the phase change may be controlled. This applied voltage is controlled so that the phase φ of the light entering the phase change portions 12a to 12c will change in the range of −π≦φ≦π.

The greater the mount of the phase change by the phase change portions 12a to 12c is, the greater the magnitude of the change of the speckle pattern on the screen is. For this reason, by controlling the phase change portions 12a to 12c so that the amount of the phase change will be greater, the light intensity appears to be averaged to the observer's eye and the speckle noise may be reduced.

The beams that have undergone the phase change by the phase change portions 12a to 12c are changed to the parallel light by the collimating lenses 13a to 13c. The beams outgoing from the collimating lenses 13a to 13c are merged by the dichroic mirrors 14a to 14c. The dichroic mirrors 14a to 14c are mirrors that reflect only their specific wavelengths, respectively and, by the dichroic mirror 14a reflecting the red beam, the dichroic mirror 14b reflecting the green beam, and the dichroic mirror 14c reflecting the blue beam, the laser beams are merged into a flux. While the dichroic mirror is used for merging, other methods may be used such as a cross-prism.

The merged beam is irradiated onto the MEMS mirror 15 and forms an image on the screen 16 by the scanning system. The MEMS mirror 15 is a biaxial MEMS mirror including an actuator and a micro-mirror and has the angle of the micro-mirror controlled in X direction (horizontal direction) and Y direction (vertical direction). The beam entering the micro-mirror is reflected so as to scan on the screen 16. At this moment, since the color and intensity of the R, G, and B laser beams are individually modulated and controlled, the light outgoing from the MEMS mirror 15 is projected on the screen 16, with its color and intensity controlled with respect to each pixel of the video, and forms an image by scanning at high speed like a CRT (Cathode-ray Tube).

While the biaxial MEMS mirror is used as the MEMS mirror 15 in the present embodiment, two uniaxial MEMS mirrors combined may be used. In this case, a two-dimensional image may be obtained with one mirror performing the scanning in the horizontal direction and the other mirror performing the scanning in the vertical direction. While the image display apparatus according to the present invention is equipped with an image forming means for forming the image, this image forming means should preferably form the image by the scanning system as exemplified. Since the image is formed by scanning the laser beam on the screen, the beam irradiated from the laser light source may be phase-changed and projected on the screen, with its beam diameter (irradiation spot diameter) kept small and without enlargement. By employing such a scanning system as well, optical members may be made smaller and the cost of the apparatus may be reduced.

Since the light irradiated on the screen 16 is changing the phase at high speed by the phase change portions 12a to 12c, an interference pattern on the screen 16 changes at high speed. For this reason, to the human eye the intensity appears to be averaged and the speckle noise appears to be reduced.

As described above, the image display apparatus 1 has the phase change portions 12a to 12c using the electro-optical crystal with its refractive index changed by the applied electric field and providing on the path of the beam emitted from the laser light source and changes the phase of the beam at high speed, constantly changing the interference pattern on the screen 16 at high speed. For this reason, to the eye of the human being as the observer, the intensity is averaged and the speckle noise is no longer visible and the image quality may be prevented from deteriorating.

The phase change, which may be controlled by changing the voltage applied to the electro-optical crystal, does not need the mechanical structure and as a result, makes it possible to configure the image display apparatus as a simple, small-size apparatus, to prevent shortening of life because of no mechanical failures, and to suppress the noise. Further, since the pattern of the phase change may be freely controlled by the voltage applied to the electro-optical crystal, namely, since arbitrary phase change may be made, optimum setting (adjustment) may be performed easily depending on the type of the light source and of the screen. This enables the image display apparatus to have high versatility.

In the above description, the intensity is averaged and the speckle noise is reduced by making the phase change at the speed higher than that perceivable to the human being but, in combination with such control by the phase change portions 12a to 12c, or even by lowering the frequency to some extent, the control may be executed that will bring the pattern of the phase change (how to cause interference, i.e., interference change) to such complexity as to be unperceivable to the human being.

How to cause interference (speckle pattern) may be changed by, for example, forming the control signal of the phase change portions 12a to 12c as a random signal. That is to say, the phase change portions 12a to 12c may drive to control the electro-optical crystal so as to change the phase of the light emitted from the laser light source 10 at random. By forming the control signal as the random signal, the speckle pattern on the screen 16 may be changed with further complexity and the lowering of the image quality due to the speckle noise may be prevented.

Other than the random signal, the control signal may be employed that has a waveshape of a square wave, a triangle wave, a sinusoidal wave, etc. The square wave takes only two values and therefore, the control signal of the waveshape of a wave constantly changing its phase such as the sinusoidal wave is capable of changing the speckle pattern with more complexity.

While description has been made on the premise that the phase change portions 12a to 12c are controlled by the same control signal, the phase change portions 12a to 12c may be controlled separately. In such a case, since the amount of the phase change depends on the wavelength of the beam, the phase change may be set depending on each laser to achieve more efficient phase change.

Here, when the phase change portions 12a to 12c are of same kind, the amount of the phase change differs, depending on the wavelength, for the same applied voltage value. Generally speaking, since the amount of the phase change is inversely proportional to the wavelength, the amount of the phase change on the side of a longer wavelength of red, etc., is smaller than the amount of the phase change on the side of a shorter wavelength of blue, etc., for the same voltage value. Therefore, by separately controlling the phase change portions 12a to 12c and controlling the applied voltage to an appropriate voltage value depending on the wavelength of the incoming light, the phase change for each wavelength may easily be controlled and the amount of the phase change for each wavelength may be made equal. By changing the phase change amount φ in the range of −π≦φ≦π in all wavelengths, the amount of change of the pickle pattern on the screen becomes great, the intensity appears to be averaged to the observer's eye, and the speckle noise may be reduced.

The amount of the phase change is also proportional to the length of the electro-optical crystal and therefore, by using the phase change portions with the electro-optical crystals of the length differing depending on the wavelength, the control may be performed by the same control signal so that the amount of the phase change for each wavelength will be made equal.

### Second Embodiment

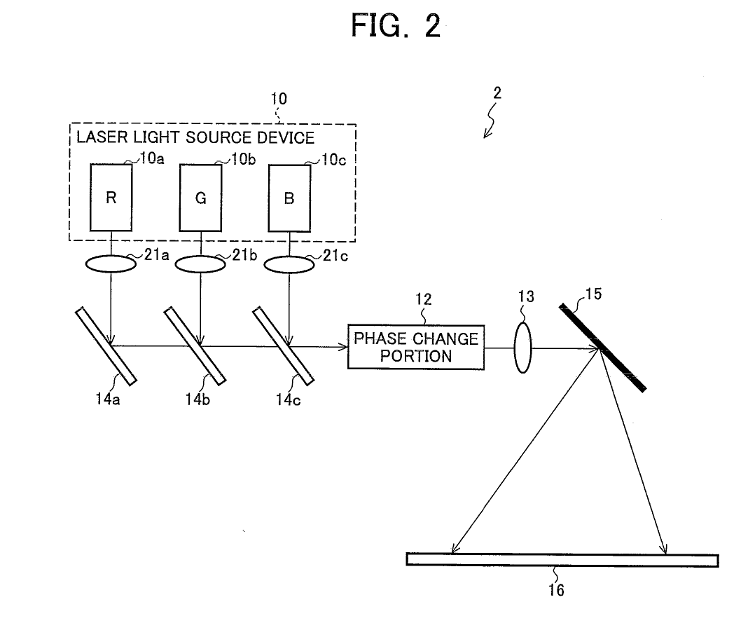

FIG. 2 is a diagram of a configuration example of the image display apparatus according to a second embodiment of the present invention and reference numeral 2 in the drawing represents the image display apparatus. In FIG. 2, same parts as those of the image display apparatus 1 in the first embodiment are given same reference numerals and description thereof including application examples thereof are omitted. Portions bearing same figures such as the phase change portions 12a to 12c and a phase change portion 12 are assumed to have the same property.

In the present embodiment, one phase change portion 12 is arranged after the merging of the beams emitted from the R, G, and B laser light sources 10a to 10c, thereby achieving the phase change and reducing the speckle noise on the screen 16, only by a single phase change portion 12. This enables the configuration to be simplified and the size and the cost to be reduced. The speckle noise is reduced in the same manner as described in the first embodiment.

Configuration and operation will be described of the image display apparatus 2 exemplified in FIG. 2. The image display apparatus 2 is composed of the laser light source device 10 including the laser light sources 10a to 10c of R (red), G (green), and B (blue), collimating lenses 21a to 21c that collimate output beams of light into the parallel light, the dichroic mirrors 14a to 14c that reflect only wavelengths of respective beams, the phase change portion 12 that changes the phase of the laser beam, the MEMS mirror 15 that forms the image by the scanning system, and the screen 16 that displays the image.

The beams emitted from the R, G, and B laser light sources are changed to the parallel light by the collimating lenses 21a to 21c. The laser beams as the parallel light are merged by the dichroic mirrors 14a to 14c into a flux of beam. Merged laser beam enters the phase change portion 12 arranged on the path of the beam. The incoming beam undergoes high-speed phase change by the phase change portion 12. In this case, the phase change portion should desirably be designed to phase-change the wavelength of the green laser source most efficiently. From the human visual sensitivity, the green is the wavelength range at which the human being senses the brightness more acutely than in the case of the red and the blue and by making the phase change with the green mainly, the speckle noise may be reduced efficiently.

The beam that has undergone the phase change at the phase change portion 12 is collimated into the parallel light by the collimating lens 13 and enters the MEMS mirror 15. The beam is then projected onto the screen 16 by the biaxial MEMS mirror 15, forming the image on the screen 16 by the scanning system. Since the beam projected onto the screen 16 has undergone the high-speed phase change at the phase change portion 12, the speckle noise is reduced and the image quality is prevented from deteriorating.

As described above, in the present embodiment, by which the speckle noise may be reduced only by a single phase change portion 12 in addition to other effects of the first embodiment, the number of parts is decreased to enable a reduced cost and a smaller size. The power to drive the phase change portion 12 may be reduced to enable less power consumption.

### Third Embodiment

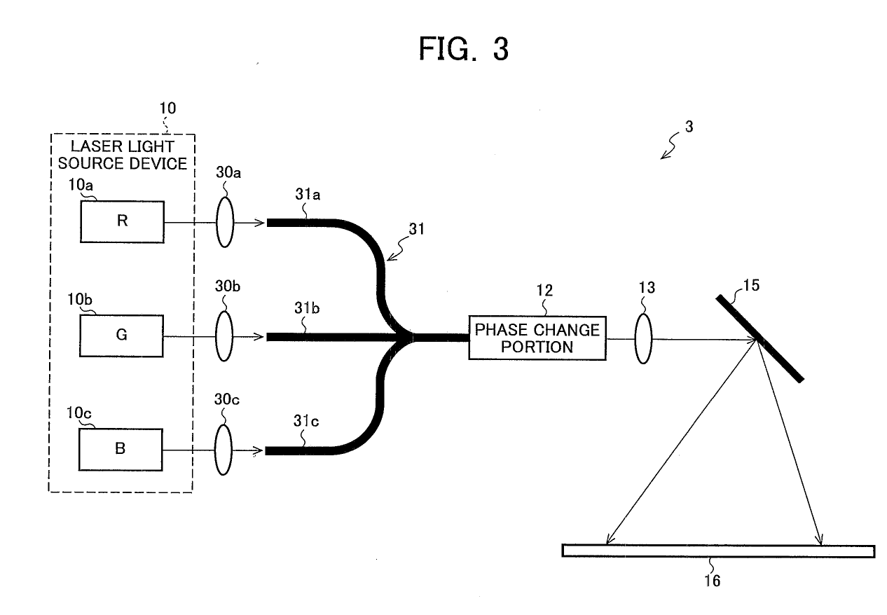

FIG. 3 is a diagram of a configuration example of the image display apparatus according to a third embodiment of the present invention and reference numeral 3 in the drawing represents the image display apparatus. In FIG. 3, same parts as those of the image display apparatus 1 in the first embodiment are given same reference numerals and description thereof including application examples thereof are omitted.

In the present embodiment, the light path may freely be controlled by propagating the light emitted from the laser light source to the phase change portion 12 by way of an optical fiber 31. This makes the configuration simplified and the layout free in arrangement of parts, enabling the size and the cost to be reduced. The speckle noise is reduced in the same manner as described in the first embodiment.

Configuration and operation will be described of the image display apparatus 3 exemplified in FIG. 3. The image display apparatus 3 causes the beams emitted from the R, G, and B laser light sources of the laser light source device 10 to enter entrances 31a to 31c of the optical fiber 31 by way of condenser lenses 30a to 30c. The optical fiber 31 has its exit sides coupled and the beams propagating in the optical fiber 31 are merged in the course of propagation. The exit of the optical fiber 31 is connected to the phase change portion 12 and the light outgoing from the optical fiber immediately enters the phase change portion 12. The phase change portion 12 should preferably be the optical waveguide using the electro-optical crystal as described above and the incoming light undergoes the phase change while it travels in the waveguide. The voltage to the phase change portion 12 is applied at the frequency of 60 Hz or more and the light outgoing from the phase change portion 12 is phase-changed at that frequency.

The beam outgoing from the phase change portion 12 is collimated into the parallel light by the collimating lens 13 and is irradiated to the MEMS mirror 15, which projects the incoming beam onto the screen 16. Since the color and intensity of the R, G, and B laser beams are individually modulated and controlled, the light outgoing from the MEMS mirror 15 is projected on the screen 16, with its color and intensity controlled with respect to each pixel of the video, and forms an image by scanning at high speed like the CRT.

In FIG. 3, as a preferable example of providing one phase change portion 12 as in the second embodiment, the phase change portion 12 is arranged after the merging of the beams by the optical fiber 31 and the present embodiment has been described based on such arrangement. As in the first embodiment, however, three phase change portions and three condenser lenses may be arranged between the condenser lenses 30a to 30c and the entrances 31a to 31c of the optical fiber 31 (before the optical fiber 31) to perform the phase change for each of the laser light sources 10a to 10c. In this case, arrangement of optimum phase change portions depending on the wavelength of the laser enables the phase change to be performed efficiently.

As described above, in the present embodiment, the light path may freely be curved by using the optical fiber for the propagation of the light, in addition to other effects of the first or second embodiment. This enables a free layout and a smaller size of the apparatus as a whole. A decreased number of parts and a simplified configuration enable the cost to be reduced. With respect to the connection and the propagation of the phase change portion 12 and the optical fiber 31, a technology of connecting and propagating with low loss and with efficiency is in practical use in the field of optical communication, etc., and therefore, a bright image may be obtained.

### Fourth Embodiment

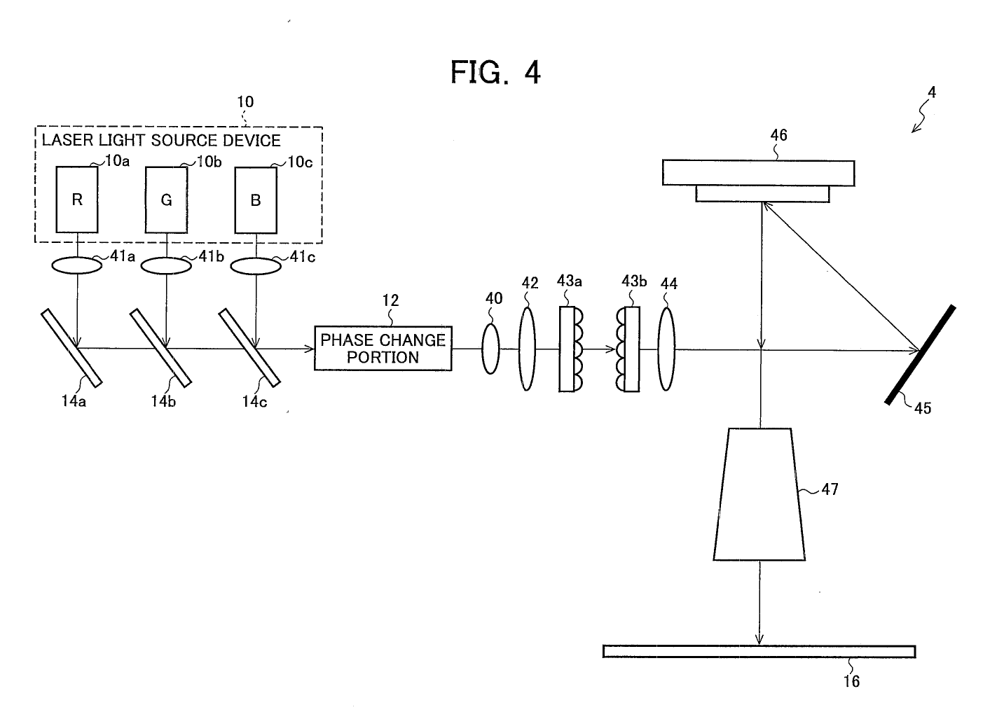

FIG. 4 is a planar model diagram of an internal configuration of the image display apparatus according to a fourth embodiment of the present invention and reference numeral 4 in the drawing represents the image display apparatus. In FIG. 4, same parts as those of the image display apparatus 1 in the first embodiment are given same reference numerals and description thereof including application examples thereof are omitted.

In the present embodiment, the speckle noise is reduced by causing the light whose phase is changed at high speed by the phase change portion 12 to form the image on the screen 16, using an image forming means by a spatial light modulator 46. That is to say, in the present embodiment, with the image forming means in the first through the third embodiments replaced by the image forming means provided with the spatial light modulator (spatial light modulating device) 46, the image is formed by the spatial light modulator 46. The speckle noise is reduced in the same manner as described in the first embodiment.

Configuration and operation will be described of the image display apparatus 4 exemplified in FIG. 4. The image display apparatus 4 is composed of the laser light source device 10 including the laser light sources 10a to 10c of R (red), G (green), and B (blue), collimating lenses 41a to 41d that collimate beams of light into the parallel light, the dichroic mirrors 14a to 14c, the phase change portion 12 that changes the phase of the laser beam, a diffusion device 40 that enlarges a beam diameter of the laser beam, a collimating lens 42 to change the beam to the parallel light, a first fly-eye lens 43a, a second fly-eye lens 43b, a condenser lens 44, a mirror 45, the spatial light modulator 46, a projection lens 47, and the screen 16 that displays the image.

The beams emitted from the R, G, and B laser light sources 10a to 10c are changed to the parallel light by the collimating lenses 41a to 41c. The laser beams as the parallel light are merged by the dichroic mirrors 14a to 14c into a flux of beam. Merged laser beam enters the phase change portion 12 arranged on the path of the beam. The incoming beam undergoes high-speed phase change by the phase change portion 12. The beam whose phase is changed by the phase change portion 12 has its irradiation diameter enlarged by the diffusion device 40.

Diffused light, after collimated into the parallel light by the collimating lens 42, is uniformized by a pair of fly-eye lenses 43a and 43b. The uniformized light goes out of the condenser lens 44 and after reflected by the mirror 45, is focused onto the spatial light modulator 46. Here, the fly-eye lenses 43a and 43b are a device that performs mixing of the light by breaking up the spot diameter into small ones and causing their respective cross-sections to be focused, mutually overlapping, on the surface of the spatial light modulator 46. The spatial light modulator 46 is a DMD (Digital Micromirror Device: registered trademark) and forms the image by driving a large number of micromirrors. The light irradiated from the spatial light modulator 46 is enlarged and projected onto the screen 16 by the projection lens 47.

While the DMD (registered trademark) is used for the spatial light modulator 46, the spatial light modulator by the liquid crystal as well may be used. The configuration may also be used of providing the spatial light modulator 46 for each laser light source and merging the beams after modulated.

As described above, in the present embodiment, the light constantly changing its phase is modulated by the spatial light modulator that generates image-related modulated light and is projected, through the projection lens 47, on the screen 16 to form the image thereon. In the present embodiment as well, like the effects of the first through the third embodiments, since the beam projected on the screen has its phase changed at high speed by the phase change portion 12, the speckle noise is reduced and the image quality is prevented from deteriorating. With no mechanical structure provided for the phase change, a smaller size, a reduced number of parts, and a longer life may be achieved. A sufficient speed can be realized for the phase change.

1-13. (canceled)

14. An image display apparatus comprising:
a light source device that emits a coherent light;
an image forming means that forms an image on a screen; and
a phase change portion disposed on a path of the light from its emission from the light source device until its arrival at the image forming means, wherein
the phase change portion comprises an electro-optical crystal, the phase change portion driving to control a voltage applied to the electro-optical crystal so as to change phase of the light to be projected onto the screen, the phase change portion changing the phase of the light to be projected onto the screen depending on the wavelength of the light emitted from the light source device.

15. The image display apparatus as defined in claim 14, wherein
the phase change portion is an optical waveguide using the electro-optical crystal.

16. The image display apparatus as defined in claim 14, wherein
the phase change portion drives to control the electro-optical crystal with the applied voltage of a frequency of 60 Hz or more.

17. The image display apparatus as defined in claim 14, wherein
the phase change portion drives to control the voltage applied to the electro-optical crystal so as to change at random the phase of the light emitted from the light source device.

18. The image display apparatus as defined in claim 14, wherein
the light source device comprises a plurality of laser light sources, wherein
the phase change portion is individually disposed on a path of each of the lasers emitted from the plurality of laser light sources, and wherein
the plurality of phase change portions disposed change the phase of the lasers to be projected onto the screen depending on the wavelength of the lasers emitted from the laser light sources corresponding to the paths on which the plurality of phase change portions are disposed.

19. The image display apparatus as defined in claim 14, wherein
the light source device comprises a plurality of laser light sources, and wherein
the phase change portion is singly disposed on a path of light after merging of the lasers emitted from the plurality of laser light sources, the phase change portion changing the phase of the laser to be projected onto the screen depending on the wavelength of the laser emitted from predetermined one of the plurality of laser light sources.

20. The image display apparatus as defined in claim 14, wherein
the electro-optical crystal has a primary electro-optical effect of changing its refractive index in proportion to applied electric field.

21. The image display apparatus as defined in claim 20, wherein
the electro-optical crystal is lithium niobate.

22. The image display apparatus as defined in claim 14, wherein
the electro-optical crystal has a secondary electro-optical effect of changing its refractive index in proportion to square of applied electric field.

23. The image display apparatus as defined in claim 14, comprising an optical fiber that propagates the light emitted from the light source device to the phase change portion.

24. The image display apparatus as defined in claim 14, wherein
the light source device is a semiconductor laser.

25. The image display apparatus as defined in claim 14, wherein
the image forming means forms the image by a scanning system.

26. The image display apparatus as defined in claim 14, wherein
the image forming means comprises a spatial light modulating device and forms the image by the spatial light modulating device.
